(19) United States
(12) Patent Application Publication
(10) Pub. No.: US 2007/0049094 A1
(43) Pub. Date: Mar. 1, 2007

(54) Apparatus to connect substrates

(75) Inventor: Jae-sub Yun, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/490,059

(22) Filed: Jul. 21, 2006

(30) Foreign Application Priority Data
Aug. 27, 2005 (KR) 2005-79105

(51) Int. Cl. H01R 13/62

(52) U.S. Cl. 439/329

(57) ABSTRACT

An apparatus to connect substrates includes a first substrate having at least one first contact, a second substrate having at least one second contact corresponding to the at least one first contact on the first substrate, and a connector to couple the first substrate and the second substrate to maintain the contacts in contact with each other. Thus, the substrate connecting apparatus is capable of coupling substrates and has a simple structure and a minimal thickness.

### CROSS-REFERENCE TO RELATED APPLICATIONS

This application claims the benefit of Korean Patent Application No. 2005-0079105, filed on Aug. 27, 2005, in the Korean Intellectual Property Office, the disclosure of which is incorporated herein by reference in its entirety.

### BACKGROUND OF THE INVENTION

1. Field of the Invention

The present general inventive concept relates to an apparatus to connect substrates, and more particularly, to an apparatus to connect substrates having an improved structure to couple the substrates to each other in a simple manner.

2. Description of the Related Art

A substrate is widely used for a component of an electrical or electronics product in home appliances, such as a digital TV, a computer, etc., and in high-technology communications apparatuses. The substrate typically comprises a signal line arranged thereon, thereby electrically connecting electrical components to each other. The electrical components include, for example, an integrated circuit, a resistor, a switch, or signal lines, and the signal line can transmit a signal therebetween. Also, a highly efficient and multi-functional substrate having a complicated configuration may be coupled with another substrate so as to electrically connect electric power, circuit, etc. Substrates are typically connected to each other by a soldering method, a connector, or the like.

Korea Patent Registration No. 10-0278690 (Oct. 21, 2000) describes a conventional connector for coupling a first substrate and a second substrate. The conventional connector comprises a connector housing, a connector terminal and a circuit connecting part. The connector terminal has a pin shape and is kept in contact with the first substrate, thereby being electrically connected thereto and the circuit connecting part is kept in contact with the second substrate. Also, the conventional connector comprises a circuit clamp keeping the first substrate in contact with the connector terminal and the second substrate in contact with the circuit connecting part, respectively. The conventional connector with this configuration improves space efficiency by disposing the connector terminal and the circuit connecting part at different heights.

However, the conventional connector comprises components, such as the connector terminal of the pin shape and the circuit connecting part, on which signal lines are formed. Thus, the conventional connector described above has disadvantages in that a cost is high due to the complicated configuration and manufacturing process of the conventional connector. Additionally, a thickness of the conventional connector is large, since both substrates are coupled to the connector. Moreover, an inductance is generated in the connector terminal of the pin shape according to a length of the pin, and the connector terminal may not be kept in uniform contact with the substrate, thereby possibly generating electromagnetic wave.

### SUMMARY OF THE INVENTION

Accordingly, the present general inventive concept provides an apparatus to connect substrates in a simple manner and having a connector with a minimal thickness.

The present general inventive concept also provides an apparatus to connect substrates capable of decreasing electromagnetic wave generation and to provide uniform contact between the substrates.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an apparatus to connect substrates, the apparatus comprising a first substrate having at least one first contact, a second substrate having at least one second contact corresponding to the at least one first contact on the first substrate, and a connector to couple the first substrate and the second substrate to maintain the first and second contacts in contact with each other.

The connector may comprise a connector door which faces the first substrate with the second substrate interposed therebetween, and a hinge by which the connector door rotates with respect to the first substrate between a coupled position and a released position.

The connector may further comprise an elastic member disposed between the connector door and the second substrate to elastically press the second substrate.

The elastic member may be coupled on a lower surface of the connector door toward the first substrate.

The connector door may comprise a stopper protrusion formed thereon, and the hinge may comprise a stopper protrusion accommodating part interlocking with the stopper protrusion such that the connector is maintained in the coupled position and the second substrate is pressed against the first substrate.

The elastic member may comprise a friction protrusion formed on a surface thereof in contact with the second substrate.

The first substrate may comprise a printed circuit board (PCB), and the second substrate may comprise a flexible printed circuit board (FPC).

The connector door may comprise an elastic material.

The foregoing and/or other aspects of the present general inventive concept may also be achieved by providing a substrate connecting apparatus, comprising a first substrate, a second substrate disposed on the first substrate, and a connector having a first portion rotatably connected to the first substrate and a second portion to elastically contact the second substrate and apply a predetermined elastic force thereto such that the first and second substrates are maintained in a fixed position with respect to one another according to a rotation of the first portion with respect to the first substrate.

The foregoing and/or other aspects of the present general inventive concept may also be achieved by providing a substrate connecting apparatus, comprising a first substrate having a first electrical contact disposed thereon, a second substrate having a second electrical contact disposed thereon, a hinging part disposed on the first substrate, and a connector door connected to the hinging part to be rotatable between first and second positions and having a pressing surface to press the first and second substrates together such that the first and second electrical contacts are in contact when in the first position, and the pressing surface is moved away from the first and second substrates in the second position.

### BRIEF DESCRIPTION OF THE DRAWINGS

The above and/or other aspects of the present general inventive concept will become apparent and more readily appreciated from the following description of the embodiments, taken in conjunction with the accompany drawings of which:

FIG. 1 is an exploded perspective view illustrating an apparatus to connect substrates according to an embodiment of the present general inventive concept;

FIG. 2 is a lateral sectional view illustrating the substrate connecting apparatus of FIG. 1;

FIG. 3 is a front sectional view illustrating the substrate connecting apparatus of FIG. 1; and

FIGS. 4A through 4C are schematic views illustrating a process of connecting substrates according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

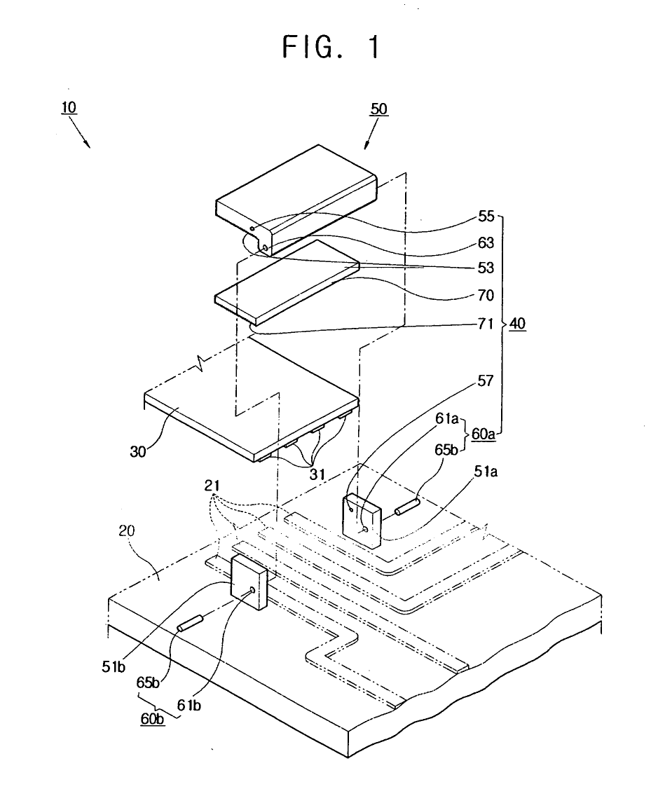

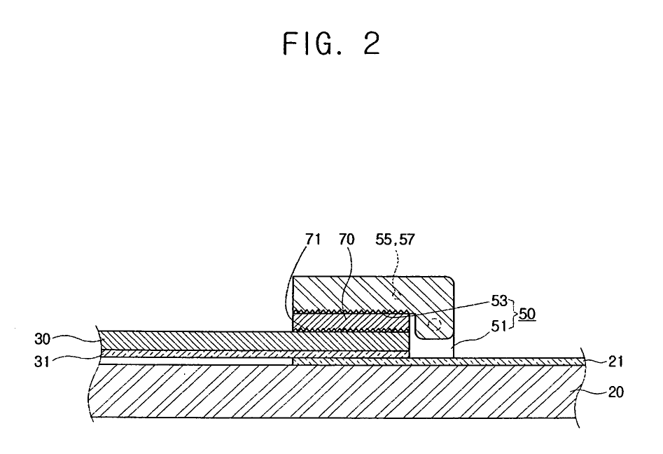

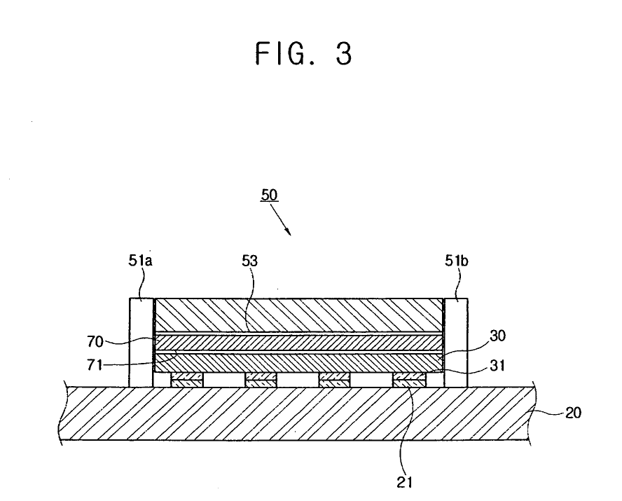

FIG. 1 is an exploded perspective view illustrating an apparatus 10 to connect substrates (i.e., a substrate connecting apparatus) according to an embodiment of the present general inventive concept, FIG. 2 is a lateral sectional view illustrating the substrate connecting apparatus 10, and FIG. 3 is a front sectional view illustrating the substrate connecting apparatus 10. As illustrated in FIGS. 1 through 3, the apparatus 10 to connect the substrates comprises a first substrate 20 having at least one first contact 21, a second substrate 30 having at least one second contact 31 corresponding to the at least one first contact 21, and a connector 40 coupling the first substrate 20 and the second substrate 30 so that the first contact 21 is maintained in contact with the second contact 31.

The first substrate 20 has the at least one first contact 21. The first substrate 20 may be larger in area and thickness than the second substrate 30. Alternatively, the first substrate 20 may be smaller than the second substrate 30. Further, the first substrate 20 is electrically connected to the second substrate 30 by the connector 40 with the first contact 21 making contact with the second contact 31. The first substrate 20 may comprise a printed circuit board (PCB).

The second substrate 30 comprises the second contact 31 corresponding to the first contact 21 on the first substrate 20. The second substrate 30 may be smaller in area and thickness than the first substrate 20. Alternatively, the second substrate 30 may be larger than the first substrate 20. The second substrate 30 is electrically connected to the first substrate 20 by the connector 40. The second substrate 30 may comprises a flexible printed circuit board (FPC) so as to easily move or assemble/disassemble.

The connector 40, as illustrated in FIG. 1, couples the first substrate 20 and the second substrate 30 so that the first contact 21 is maintained in contact with the second contact 31. The connector 40 comprises a connector door 50 supported by the first substrate 20 and an elastic member 70 disposed between the connector door 50 and the second substrate 30 to elastically press the second substrate 30 toward the first substrate 20. The connector 40 may not comprise an electrical contact, a connect pin, and etc.

The first contact 21 and the second contact 31 may comprise signal lines so as to be supplied with electric power or to transmit signals, respectively.

As illustrated in FIGS. 1 and 2, the connector door 50, is supported by the first substrate 20 and rotates with respect to the first substrate 20. The connector door 50 comprises a pair of supporting parts 51 including first and second supporting parts 51a and 51b supported by the first substrate 20 and a press part 53 coupled with the pair of the supporting parts 51 (i.e., the first and second supporting parts 51a and 51b) to press the second substrate 30 toward the first substrate 20 while contacting the elastic member 70. The press part 53 may have a surface to face the second substrate 30. Further, a hinge 60 including first and second hinge parts 60a and 60b is formed at the connector door 50 so that the connector door 50 may rotate between a coupled position and a released position with respect to a surface of the first substrate 20. The connector door 50 and the elastic member 70 may be formed in a signal body, or the elastic member 70 may be formed independently and then coupled with the connector door 50.

As illustrated in FIGS. 1 through 3, the supporting part 51 of the connector door 50 is supported by the first substrate 20 and is provided in the pair of the first and second supporting parts 51a and 51b. A supporting part pivot hole 61 including first and second supporting part pivot holes 61a and 61b is formed in the supporting part 51 so as to be rotatably coupled with the press part 53 via the hinge 60 (i.e., the first and second hinge parts 60a and 60b, respectively). Also, the supporting part 51 comprises a stopper protrusion accommodating part 57 formed therein corresponding to the press part 53 so that the press part 53 is maintained at the coupling position. The stopper protrusion accommodating part 57 may be formed on one or more of the first and second supporting parts 51a and 51b.

The press part 53 is coupled with the pair of the supporting parts 51 (i.e., the first and second supporting parts 51a and 51b) and presses the second substrate 30 toward the first substrate 20 while making contacting with the elastic member 70. The press part 53 comprises a press part pivot hole 63 formed therein so as to be rotatably coupled with the supporting part 51 and the hinge 60. The press part 53 comprises the stopper protrusion 55 formed thereon corresponding to the stopper protrusion accommodating part 57 of the supporting part 51 so as to maintain the coupled position. Alternatively, the supporting part 51 may comprise the stopper protrusion 55 formed thereon, and the press part 53 may comprise the stopper protrusion accommodating part 57 formed therein. The elastic member 70 may be a material (e.g., rubber or foam) that can be compressed by a force of the press part 53 when the connector door 50 is moved to the coupled position such that the elastic member 70 exerts a reactive force on the second substrate 30 toward the first substrate 20.

A press protrusion (not shown) may be formed on a surface of the press part 53 where the press part 53 contacts the elastic member 70 so as to increase friction between the press part 53 and the elastic member 70. The press protrusion may be spread along the press part 53 or may be disposed along a lengthwise direction thereof to have a triangle shape section. In other words, the press protrusion may be formed on the surface of the press part 53 to have a predetermined shape (e.g., a saw tooth shape) such that friction between the surface of the press part 53 and the elastic member 70 is increased. Also, the press part 53 may comprise the elastic member 70 coupled therewith by a bonding material in a single body.

Accordingly, the friction between the press part 53 and the elastic member 70 increases, thereby maintaining the press part 53 securely coupled to the elastic member 70. The connector 40 may not comprise an electrical contact such as a connect fin, and thus the configuration thereof is simple and electromagnetic wave generation may be minimized by directly contacting the contacts (i.e., the first and second contacts 21 and 31) of the substrates (i.e., the first and second substrates 20 and 30) to each other, respectively. In other words, since no extra connection pin is necessary, the electromagnetic wave generation can be minimized.

As illustrated in FIG. 1, the hinge 60 having the first and second hinge parts 60a and 60b couples the first and second supporting parts 51a and 51b of the supporting part 51 with the press part 53 so that the connector door 50 rotates between the coupled position and the released position with respect to the surface of the first substrate 20. The hinge 60 having the first and second hinge parts 60a and 60b comprises the first and second supporting part pivot holes 61a and 61b of the supporting part pivot hole 61 provided in each of the first and second supporting parts 51a and 51b, respectively, the press part pivot hole 63 provided in the press part 53 corresponding to the supporting part pivot hole 61, and a rotating pin 65 having first and second rotating pins 65a and 65b to couple the supporting part pivot holes 61a and 61b and the press part pivot hole 63 so that the press part 53 rotates with respect to the first and second supporting parts 51a and 51b.

The first and second supporting pivot holes 61a and 61b are formed in the first and second supporting parts 51a and 51b, and the press part pivot holes 63 are formed in the press parts 53 respectively so that the first and second rotating pins 65a and 65b are inserted therein. The first and second supporting part pivot holes 61a and 61b may, for example, be formed to pass through the first and second supporting parts 51a and 51b, respectively, while the press part pivot holes 63 may be formed not to pass through the press part 53. However, it should be understood that the configuration of the first and second supporting part pivot holes 61a and 61b of the support part pivot hole 61 and the press part pivot holes 63 is intended to be exemplary, and other arrangements may alternatively be used that provide for the intended purposes described herein.

The rotating pin 65 (the rotating pins 65a and 65b) may have a cylinder shape so that the press part 53 rotates with respect to the supporting parts 51 (the support parts 51a and 51b). Further, the rotating pin 65 may be a long cylinder shape so as to penetrate the press part pivot holes 63.

In an embodiment of the present general inventive concept, an elastic rotating member (e.g., a spring) may be disposed on the hinge 60 (e.g., about the rotating axis 65) to bias the connector door 50 toward the coupled position (i.e., toward the first substrate 20).

The stopper protrusion 55 is formed on the press part 53 so that the connector 40 presses the second substrate 30 toward the first substrate 20. The stopper protrusion 55 interlocks with the stopper protrusion accommodating part 57, thereby maintaining the connector 40 in the coupled position. Furthermore, the stopper protrusion 55 may comprise an elastic part (not shown), such as a spring which is elastically moved, thereby being coupled with the stopper protrusion accommodating part 57. The elastic part biases the stopper protrusion 55 to engage the stopper protrusion accommodating part 57.

The stopper protrusion accommodating part 57 is concavely formed in one or more of the first and second supporting parts 51a and 51b of the supporting part 51 so as to interlock with the stopper protrusion 55 (which may be formed on one or more lateral sides of the connector door 50), thereby maintaining the connector 40 in the coupled position in which the first and second substrates 20 and 30 are in contact with each other via the first and second contacts 21 and 31, respectively.

Accordingly, the connector 40 can couple the first substrate 20 with the second substrate 30 and maintain them in a pressed stated without a separate connecting pin, a separate electrical contact, and etc., thereby simplifying a structure for substrate coupling and decreasing a thickness of substrate coupling. That is, the first and second contacts 21 and 31 are directly connected with each other. For example, the connector 40 according to embodiments of the present general inventive concept can be used for an electronic product, such as a portable computer, thereby decreasing the thickness of the electronic product and simplifying a structure for substrate coupling. As a result, a cost may be reduced.

As illustrated in FIGS. 1 and 2, the elastic member 70 is formed between the connector door 50 and the second substrate 30 so as to elastically press the second substrate 30 toward the first substrate 20. The elastic member 70 may comprise rubber, foam, etc. The elastic member 70 may comprise a friction protrusion 71 formed on a surface thereof in contact with the second substrate 30 so as to increase friction between the elastic member 70 and the second substrate 30. The friction protrusion 71 may be a saw-toothed shape in the present embodiment, or may be spread with various shapes such as a protruding half sphere, or the like.

Accordingly, the elastic member 70 maintains the second substrate 20 coupled with the first substrate 20 uniformly and securely. Also, the friction protrusion 71 generates a friction parallel with the surface of the second substrate 20, thereby maintaining the substrates 20 and 30 securely coupled.

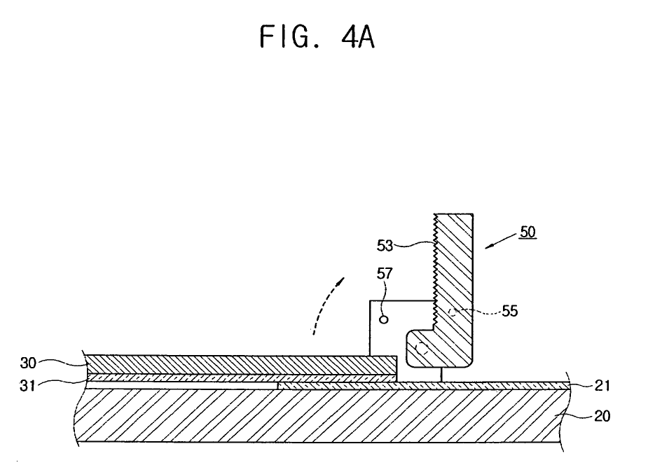

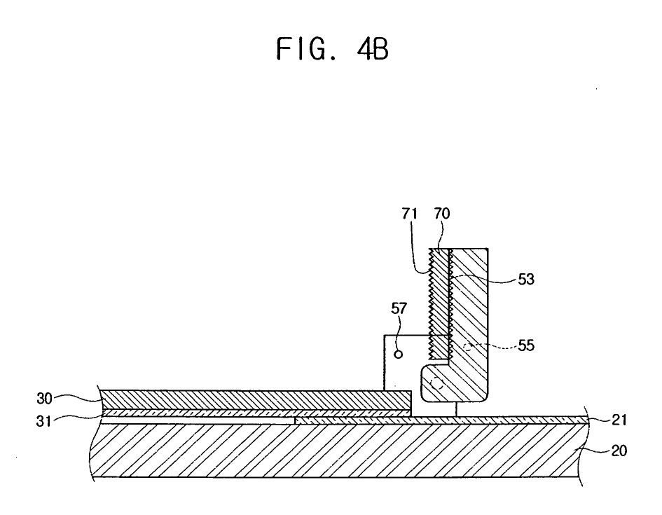

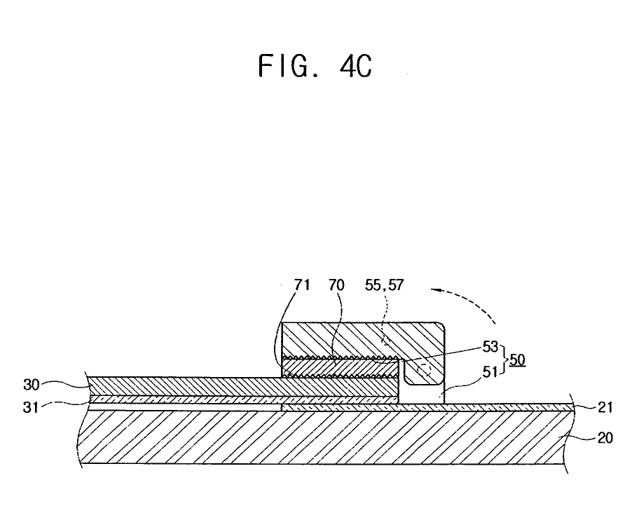

With the configuration(s) described above, a connecting process of the apparatus 10 will be described with reference to FIGS. 4A to 4C.

Contacts including the first contact 21 may be formed on the first substrate 20. The second contact 31 may be formed on the second substrate 30. The contacts may be formed by performing etching and exposure processes on a substrate.

The connector door 50 is rotatably coupled with the supporting parts 51 with the rotating pin 65 of the hinge 60. As illustrated in FIG. 4A, the first substrate 20 and the second substrate 30 are arranged so as to maintain the first contact 21 in contact with the second contact 31. As illustrated in FIG. 4B, the elastic member 70 is coupled with a lower surface of the press part 53 of the connector door 50. The connector door 50 may be coupled with the supporting part 51 after the elastic member 70 is coupled with the press part 53. As illustrated in FIG. 4C, the connector door 50 rotates to the coupled position and couples the first substrate 20 and the second substrate 30, and then elastically presses the second substrate 30 toward the first substrate 20 so as to be fastened each other. Accordingly, the stopper protrusion 55 of the connector door 50 and the stopper protrusion accommodating part 57 of the supporting part 51 interlock each other, thereby maintaining the connector 40 at the coupled position to elastically press the second substrate 30 toward the first substrate 20.

According to embodiments of the present general inventive concept, since a connector does not comprise an electrical contact such as a connect pin, a configuration thereof is simple, thereby reducing a cost and a thickness of an electronic product. Additionally, electromagnetic wave generation is minimized. Moreover, an elastic member disposed between a connector door and a second substrate uniformly presses substrates and increases friction between the elastic member and the second substrate, thereby securely coupling the substrates.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to connect substrates, the apparatus comprising:
a first substrate having at least one first contact;
a second substrate having at least one second contact corresponding to the at least one first contact on the first substrate; and
a connector to couple the first substrate and the second substrate and to maintain the first and second contacts in contact with each other.

2. The apparatus to connect the substrates according to claim 1, wherein the connector comprises:
a connector door which faces the first substrate with the second substrate interposed therebetween; and
a hinge by which the connector door rotates with respect to the first substrate between a coupled position and a released position.

3. The apparatus to connect the substrates according to claim 2, wherein the connector further comprises:
an elastic member disposed between the connector door and the second substrate to elastically press the second substrate toward the first substrate.

4. The apparatus to connect the substrates according to claim 3, wherein the elastic member is coupled on a lower surface of the connector door.

5. The apparatus to connect the substrates according to claim 3, wherein:
the connector door comprises a stopper protrusion formed thereon; and
the hinge comprises a stopper protrusion accommodating part interlocking with the stopper protrusion such that the connector is maintained in the coupled position and the second substrate is pressed against the first substrate.

6. The apparatus to connect the substrates according to claim 2, wherein:
the connector door comprises a stopper protrusion formed thereon; and
the hinge comprises a stopper protrusion accommodating part interlocking with the stopper protrusion such that the connector is maintained in the coupled position and the second substrate is pressed against the first substrate.

7. The apparatus to connect the substrates according to claim 3, wherein the elastic member comprises a friction protrusion formed on a surface thereof in contact with the second substrate.

8. The apparatus to connect the substrates according to claim 1, wherein:
the first substrate comprises a printed circuit board (PCB); and
the second substrate comprises a flexible printed circuit (FPC).

9. The apparatus to connect the substrates according to claim 2, wherein the connector door comprises an elastic material.

10. A substrate connecting apparatus, comprising:
a first substrate;
a second substrate disposed on the first substrate; and
a connector having a first portion rotatably connected to the first substrate and a second portion to elastically contact the second substrate and apply a predetermined elastic force thereto such that the first and second substrates are maintained in a fixed position with respect to one another according to a rotation of the first portion with respect to the first substrate.

11. The substrate connecting apparatus according to claim 11, wherein the first portion extends in a first direction, and the second portion extends in a second direction perpendicular to the first direction.

12. The substrate connecting apparatus according to claim 11, wherein the connector is rotatably movable between a coupled state in which the first and second substrates are in the fixed position and the second portion thereof is substantially parallel to the first and second substrates, and a released state in which the first and second substrates are released from the fixed position and the second portion thereof is not substantially parallel to the first and second substrates.

13. The substrate connecting apparatus according to claim 11, wherein the connecter comprises:
at least one supporting part extending from the first substrate perpendicular to a surface of the first substrate and having at least one support pivot hole;
at least one rotating pin having a first end disposed in the at least one support pivot hole; and
a connector door having at least one press pivot hole at a lateral side thereof being coupled to a second end of the at least one rotating pin such that the connector door is rotatable with respect to the supporting part and the first substrate.

14. The substrate connecting apparatus according to claim 13, wherein:
the connector door comprises a stopper protrusion part extending from the lateral side thereof adjacent to the at least one press pivot hole; and
the at least one supporting part comprises a stopper accommodating part disposed adjacent to the at least one support pivot hole to engage the stopper protrusion part when the connector door is moved toward the first substrate such that the first and second substrates are in the fixed position.

15. A substrate connecting apparatus, comprising:
a first substrate having a first electrical contact disposed thereon;
a second substrate having a second electrical contact disposed thereon;
a hinging part disposed on the first substrate; and
a connector door connected to the hinging part to be rotatable between first and second positions and having a pressing part to press the first and second substrates together such that the first and second electrical contacts are in contact when in the first position, and the pressing surface is moved away from the first and second substrates when in the second position.

16. The substrate connecting apparatus according to claim 15, wherein the connector door comprises a first portion rotatably connected to the hinging part and a second portion extended from the first portion and having an angle with the first portion, and the pressing part is formed on the second portion of the connector door.

17. The substrate connecting apparatus according to claim 16, wherein the second portion comprises a surface to correspond to the first and second electrical contacts.

18. The substrate connecting apparatus according to claim 16, wherein the second portion is disposed to press the second electrical contact toward the first electrical contact when the connector door is in the first position.

19. The substrate connecting apparatus according to claim 15, wherein the connector door comprises an elastic member having a friction surface facing the second substrate.

20. The substrate connecting apparatus according to claim 15, wherein:
the connector door comprises a stopper part formed on the pressing part; and
the hinging part comprises an accommodating part formed thereon at a position to be coupled to the stopper part of the connector door when the connector door is in the first position.
